(19) United States
(12) Patent Application Publication
(10) Pub. No.: US 2018/0078046 A1
(43) Pub. Date: Mar. 22, 2018

(54) PRESSURE CONTROL LAYER FOR A MATTRESS OR SEATING

(71) Applicant: MAMMOTH SPORT LIMITED, Newcastle upon Tyne (GB)

(72) Inventor: John Tuton, Newcastle upon Tyne (GB)

(21) Appl. No.: 15/563,785

(22) PCT Filed: Apr. 4, 2016
(86) PCT No.: PCT/GB2016/050947

§ 371 Date: Oct. 2, 2017

(30) Foreign Application Priority Data
Apr. 3, 2015 (GB) 1505820.9

(51) Int. Cl. A47C 27/06; A47C 27/14; B68G 11/06

(52) U.S. Cl. CPC A47C 27/064; A47C 7/20; B68G 11/06; A47C 27/144

(57) ABSTRACT

A pressure control layer (1) for use in a mattress or in a cushion for a seat. The layer (1) includes a plurality of interconnected fabric pockets (11) each enclosing at least one spring member (13). The fabric pockets (11) are made from elastic material. The pressure control layer (1) also has upper and lower fabric sheath portions (5,7), and each fabric pocket (11) has at least one elongate seam (9) formed between the upper and lower fabric sheath portions (5,7), these elongate seams (9) interconnecting and defining the periphery of the fabric pockets (11).

The present invention relates to an improved pressure control layer for incorporation into either a mattress or seating.

A mattress is used to support the body of a person who is laying repose, and seating is used to support the body of a person who is in a seated position.

A conventional mattress generally consists of a number of layers, in accordance with the requirements of a typical user, and often includes, inter alia, a plurality of springs arranged in a specific formation for ensuring that there is sufficient support whilst providing comfort for the user.

Conventional mattresses and seating function adequately to some extent, however they do not always provide adequate support for the body of the user, which can lead to discomfort and potential posture problems, genuine back problems such as spine stiffness and sciatica, as well as bed sores.

An object of the present invention is to provide an improved pressure control layer for a mattress or seating, which overcomes or at least alleviates, at least the above-mentioned disadvantage associated with the prior art.

In accordance with a first aspect of the present invention, there is provided a pressure control layer, comprising:—
(i) a plurality of interconnected fabric pockets;
(ii) a plurality of spring members, each said fabric pocket enclosing at least one spring member,

characterised in that at least one said fabric pocket is made from elastic material.

In having interconnected fabric pockets made from elastic material, this provides the advantage that the pressure control layer can form a contour around the body of a user more easily, to improve comfort, whilst still providing adequate support to the body of the user.

This provides the further advantage that there is less pressure being transferred to the body of the user as they rest on the pressure control layer, with the result that pressure relief is improved and more support is provided.

Further, this provides the advantage that the pressure control layer reacts more effectively to pressure changes in order to contour to the body of the user. This in turn, reduces pressure points and improves pressure distribution and support, whilst still providing comfort for the user.

Preferably, each said fabric pocket is made from elastic material.

Preferably, each said fabric pocket is made from terry towelling.

Alternatively, each said fabric pocket is made from polyester.

Alternatively, each said fabric pocket is made from at least one polymer.

Said interconnected fabric pockets may be elastic by means of their structure. For example, said interconnected fabric pockets may be elastic by means of the way in which they are woven during their manufacturing process.

Preferably, at least one said spring member is a helical spring.

Each said fabric pocket may enclose a plurality of said spring members.

Each said fabric pocket may enclose a plurality of said spring members in a stacked configuration.

This provides the advantage that the pressure control layer can provide a different grade of support to the user, as required.

Preferably, said pressure control layer may comprise an upper fabric sheath portion and a lower fabric sheath portion, and each said fabric pocket is defined by at least one elongate seam formed between said upper and lower fabric sheath portions, said at least one elongate seam interconnecting at least two said fabric pockets and defining the periphery of at least two said fabric pockets.

Preferably, at least one said elongate seam extends in a direction substantially perpendicular to the axis defining the height of the pressure control layer in use.

Alternatively, at least two said fabric pockets are interconnected by at least one elongate seam, wherein at least one said elongate seam extends substantially parallel to the axis defining the height of the pressure control layer in use.

Alternatively, at least two said fabric pockets are interconnected by at least one planar seam.

Preferably, at least one said seam is a heat pressed seam.

Alternatively, at least one said seam is a glued seam.

Alternatively, at least one said seam is a stitched seam.

Alternatively, said fabric pockets may be interconnected by means of a plurality of ribs.

Said pressure control layer may be incorporated into a mattress.

Alternatively, said pressure control layer may be incorporated into seating.

Said pressure control layer may further comprise a foam layer disposed above said fabric pockets, in use.

Said foam layer may comprise polyurethane.

Said pressure control layer may further comprise a fibre layer disposed above said fabric pockets, in use.

Said fibre layer may comprise natural fibre such as horse hair, wool or hemp.

Preferred embodiments of the present invention will now be described, by way of example only and not in any limitative sense, with reference to the accompanying drawings in which:—

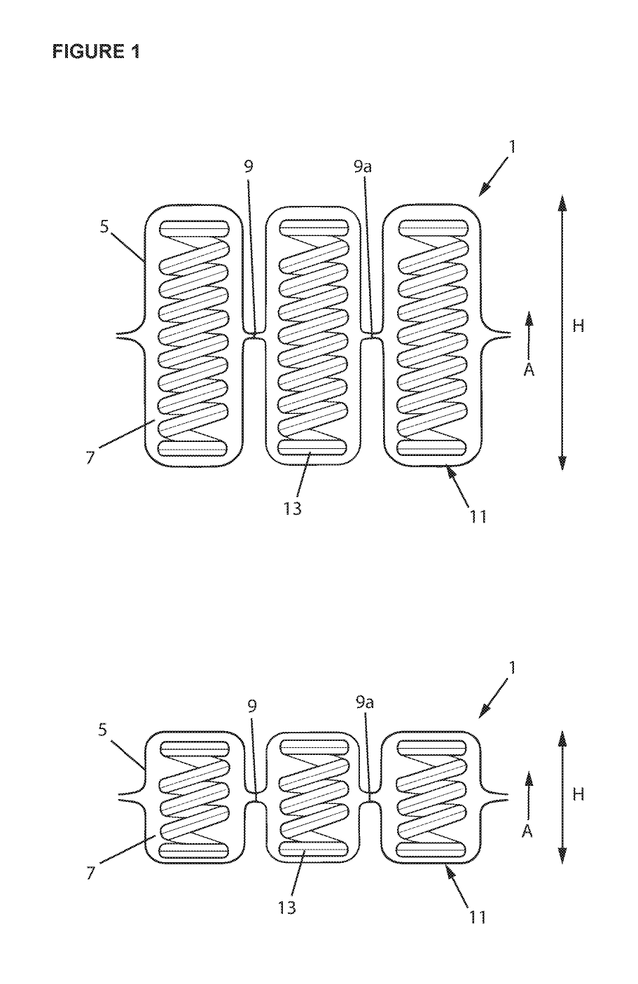

FIG. 1 shows a side cross sectional view of a portion of a pressure control layer, in accordance with a first embodiment of the present invention;

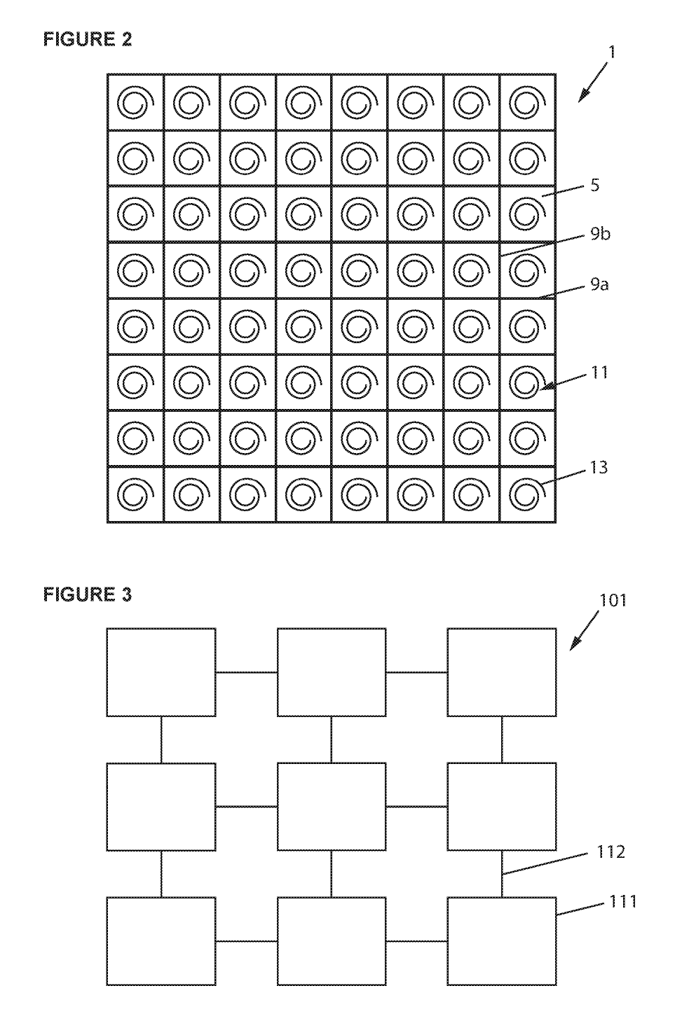

FIG. 2 shows a plan view from above of the pressure control layer of FIG. 1, showing hidden detail;

FIG. 3 shows a plan view from above of a portion of a pressure control layer in accordance with a second embodiment of the present invention;

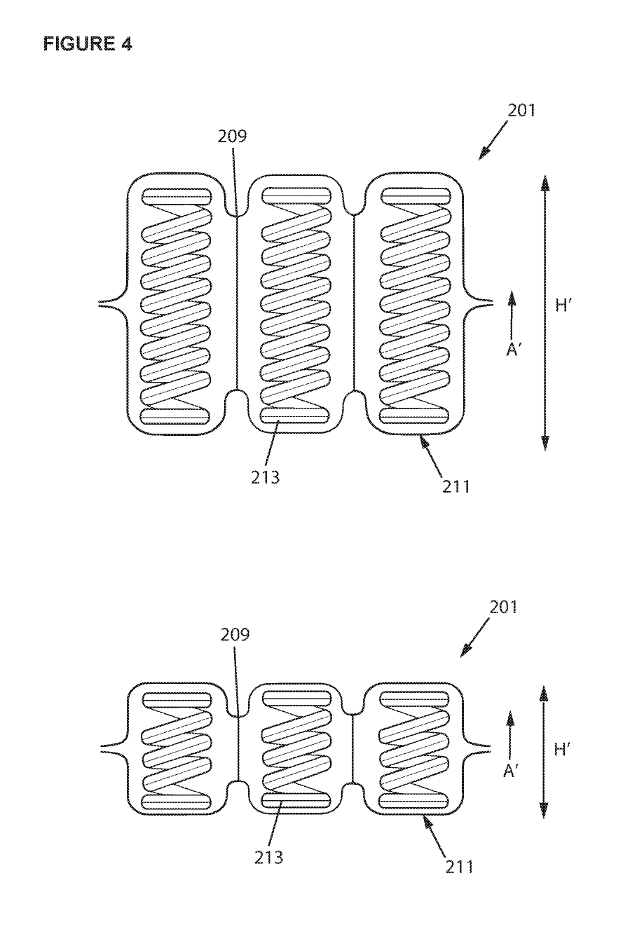

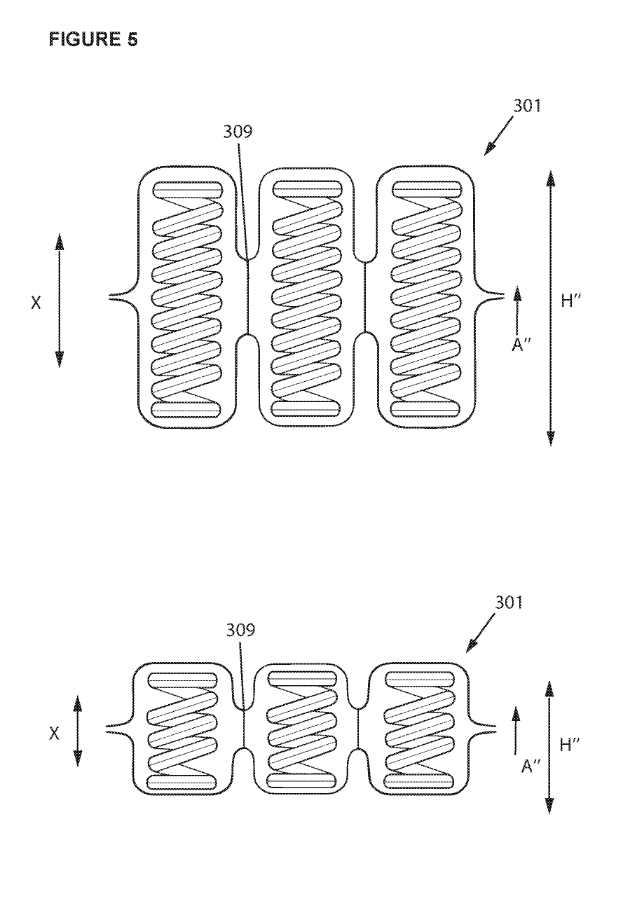

FIG. 4 shows a side cross sectional view of a pressure control layer, in accordance with a third embodiment of the present invention;

FIG. 5 shows a side cross sectional view of a pressure control layer, in accordance with a fourth embodiment of the present invention; and

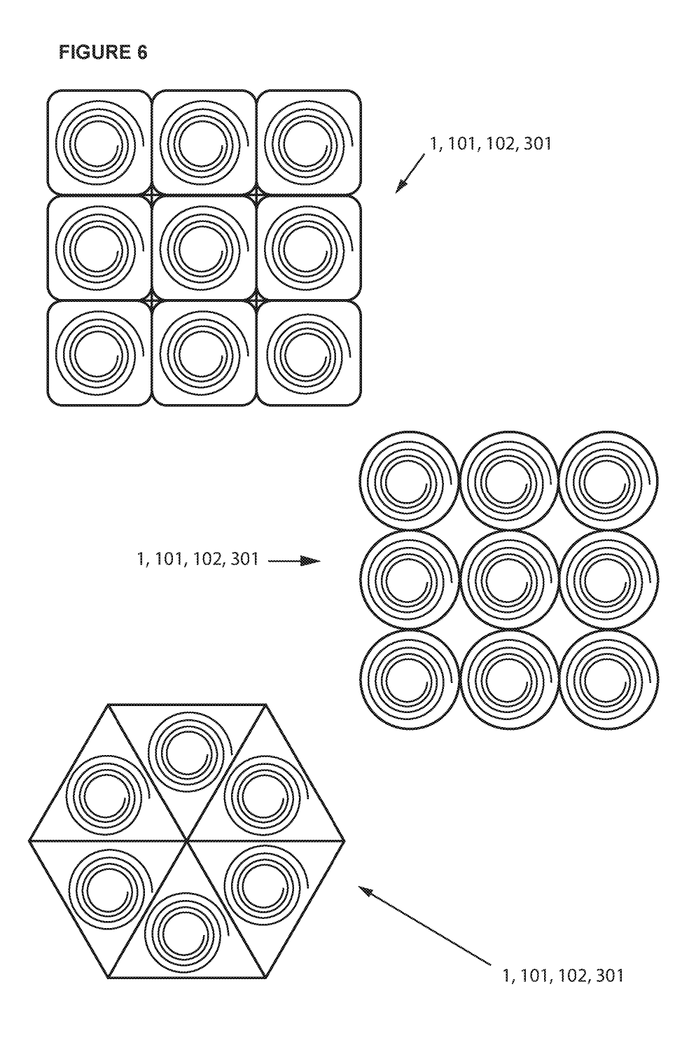

FIG. 6 shows plan views from above of various shapes of fabric pockets which can be utilised in the pressure control layer of the present invention, and some possible ways which they can be interconnected.

With reference to FIGS. 1 and 2, a first embodiment of a pressure control layer is represented generally by reference numeral 1. FIG. 1 shows two different versions of this embodiment which use different sizes of spring.

The pressure control layer 1 comprises an upper fabric sheath portion 5 and a lower fabric sheath portion 7. The upper fabric sheath portion 5 and the lower fabric sheath portion 7 are connected along elongate seams 9, which traverse the pressure control layer 1 in a grid-like formation and extend in a direction substantially perpendicular to the axis A defining the height H of the pressure control layer 1 in use.

In this embodiment, the elongate seams 9 are formed by heat pressing the fabric of the upper fabric sheath portion 5 and the lower fabric sheath portion 7 together, but it is to be appreciated that alternatively, the elongate seams 9 could be formed by means of gluing or stitching.

The presence of the grid of elongate seams 9 in the pressure control layer 1 define a plurality of fabric pockets 11 dispersed over the extent of the pressure control layer 1, whereby the periphery of each fabric pocket 11 is defined by two elongate seams 9a and two elongate seams 9b running substantially perpendicular to the elongate seams 9a. As can be clearly seen from FIG. 2 in particular, the fabric pockets 11 are interconnected by means of the linear seams 9a and 9b and are arranged in an ordered configuration such that they are arranged linearly in a grid-like configuration. As can also be clearly seen from FIG. 2 in particular, each fabric pocket 11 is substantially square in plan view.

Each fabric pocket 11 encloses a spring member, which in this embodiment is a helical spring 13. However, it is to be appreciated that each fabric pocket could alternatively enclose a plurality of helical springs 13 in a stacked configuration.

Both the upper sheath portion 5 and the lower sheath portion 7, and hence the fabric pockets 11, are made from an elastic material such as terry towelling, polyester, or a suitable polymer.

Turning now to FIG. 3, a second embodiment of a pressure control layer is represented generally by reference numeral 101.

The pressure control layer 101 a plurality of fabric pockets 111 that are interconnected by means of elongate ribs 112. As can be clearly seen from FIG. 3, the fabric pockets 111 are arranged in an ordered configuration such that they are arranged linearly, in a grid-like configuration. As can also be seen from FIG. 3, each fabric pocket 111 is substantially square in plan view.

Each fabric pocket 111 encloses a spring member, which in this embodiment is a helical spring (not shown) similar to the helical springs 13 of the embodiment of FIGS. 1 and 2. However, as with the embodiment of FIGS. 1 and 2, it is to be appreciated that each fabric pocket 111 could alternatively enclose a plurality of helical springs (not shown) in a stacked configuration.

In a similar fashion to the embodiment of FIGS. 1 and 2, the fabric pockets 111 are made from an elastic material such as terry towelling, polyester, or a suitable polymer.

Turning now to FIG. 4, a third embodiment of a pressure control layer is represented generally by reference numeral 201. FIG. 4 shows two different versions of this embodiment which use different sizes of spring.

The pressure control layer 201 comprises a plurality of fabric pockets 211 that are interconnected by means of a plurality of elongate seams 209 extending substantially parallel to the axis A′ defining the height H′ of the pressure control layer 201 in use. As can be clearly seen from FIG. 4, the elongate seams 209 are substantially the same length as the height H′.

In this embodiment, the elongate seams 209 are formed by heat pressing the fabric of adjacent fabric pockets 211 together, but it is to be appreciated that alternatively, the elongate seams 209 could be formed by means of gluing or stitching.

As with the embodiment of FIGS. 1 to 3, the presence of the elongate seams 209 interconnect the fabric pockets 211. Each pocket 211 encloses a spring member, which in this embodiment is a helical spring 213. However, it is to be appreciated that each fabric pocket 211 could alternatively enclose a plurality of helical springs 213 in a stacked configuration.

As with the embodiments of FIGS. 1 to 3, the fabric pockets 211 are made from an elastic material such as terry towelling, polyester, or a suitable polymer.

In a similar fashion to the embodiments of FIGS. 1 to 3, the fabric pockets 211 are arranged in an ordered configuration such that they are arranged linearly in a grid-like configuration.

Turning now to FIG. 5, a fourth embodiment of a pressure control layer is represented generally by reference numeral 301. FIG. 5 shows two different versions of this embodiment which use different sizes of spring. The pressure control layer 301 of this embodiment is very similar to the embodiment of FIG. 4, having linear elongate seams 309 which extend substantially parallel to the axis A″ defining the height H″ of the pressure control layer 301 in use. However, in this embodiment, the linear elongate seams 309 are slightly shorter, whereby the height X of the linear elongate seam 309 is less than the height H″ of the pressure control layer 301.

Turning now to FIG. 6, this illustrates a number of possibilities for the shape of the fabric pockets which could be used in any of the embodiments of the pressure control layer of the present invention, and also the ways in which they could be interconnected. By means of example, the fabric pockets could be triangular in plan view, circular in plan view, or square in plan view, in use. However, it is to be appreciated that any suitable shape of fabric pockets could be utilised. Moreover, there are many different options for the way in which the fabric pockets could be interconnected in any of the embodiments of the pressure control layer of the present invention, some of which are shown in this Figure. By means of example, the fabric pockets of the pressure control layer could be triangular in plan view and arranged in groups of six to form a hexagonal configuration which could be repeated over the pressure control layer as appropriate.

It is to be appreciated that the pressure control layer 1, 101, 201 301 of the present invention can be incorporated into either seating or a mattress, with further layers added to the pressure control layer 1, 101, 201, 301 as required, to suit the particular purpose. Other layers which may be incorporated in this way, in conjunction with the pressure control layer 1, 101, 201, 301 include for example, a foam layer (not shown) disposed above the pressure control layer 1, 101, 201, 301 in use, or a polyurethane layer (not shown) disposed above the pressure control layer 1, 101, 201, 301 in use, or a fibre layer (not shown) comprising horse hair, wool or hemp for example, disposed above the pressure control layer 1, 101, 201, 301 in use.

It will be appreciated by persons skilled in the art that the above embodiments have been described by way of example only, and not in any limitative sense, and that various alterations and modifications are possible without departing from the scope of the invention as defined by the appended claims.

1. A pressure control layer, comprising:—
(i) a plurality of interconnected fabric pockets;
(ii) a plurality of spring members, each said fabric pocket enclosing at least one spring member,
characterised in that at least one said fabric pocket is made from elastic material.

2. A pressure control layer as claimed in claim 1, wherein each said fabric pocket is made from elastic material.

3. A pressure control layer as claimed in claim 1, wherein said pressure control layer comprises an upper fabric sheath portion and a lower fabric sheath portion, and each said fabric pocket is defined by at least one elongate seam formed between said upper and lower fabric sheath portions, said at least one elongate seam interconnecting at least two said fabric pockets and defining the periphery of at least two said fabric pockets.

4. A pressure control layer as claimed in claim 3, wherein at least one said elongate seam extends in a direction substantially perpendicular to the axis defining the height of the pressure control layer in use.

5. A pressure control layer as claimed in claim 1, wherein at least two said fabric pockets are interconnected by at least one elongate seam, wherein at least one said elongate seam extends substantially parallel to the axis defining the height of the pressure control layer in use.

6. A pressure control layer as claimed in claim 1, wherein at least two said fabric pockets are interconnected by at least one planar seam.

7. A pressure control layer as claimed in claim 3, wherein at least one said seam is a heat pressed seam.

8. A pressure control layer as claimed in claim 3, wherein at least one said seam is a glued seam.

9. A pressure control layer as claimed in claim 3, wherein at least one said seam is a stitched seam.

10. A pressure control layer as claimed in claim 1, wherein said fabric pockets are interconnected by means of a plurality of ribs.

11. A pressure control layer as claimed in claim 1, wherein each said fabric pocket is made from terry towelling.

12. A pressure control layer as claimed in claim 1, wherein each said fabric pocket is made from polyester.

13. A pressure control layer as claimed in claim 1, wherein each said fabric pocket is made from at least one polymer.

14. A pressure control layer as claimed in claim 1, wherein at least one said spring member is a helical spring.

15. A pressure control layer as claimed in claim 1, wherein each said fabric pocket encloses a plurality of said spring members.

16. A pressure control layer as claimed in claim 15, wherein each said fabric pocket encloses a plurality of said spring members in a stacked configuration.

17. A pressure control layer as claimed in claim 1, further comprising a foam layer disposed above said fabric pockets, in use.

18. (canceled)

19. A pressure control layer as claimed in claim 1, further comprising a fibre layer disposed above said fabric pockets, in use.

20. (canceled)

21. A mattress incorporating a pressure control layer as claimed in claim 1.

22. Seating incorporating a pressure control layer as claimed in claim 1.

23.-25. (canceled)
